(19) United States
(12) Patent Application Publication
(10) Pub. No.: US 2012/0192671 A1
(43) Pub. Date: Aug. 2, 2012

(54) MOTOR-DRIVEN SELF-LOCKING ARTICULATION FOR A ROBOT ARM

(75) Inventors: Alain Riwan, Chevilly-Larue (FR); Jonathan Van Rhijn, Cachan (FR)

(73) Assignee: COMMISSARIAT A L'ENERGIE ATOMIQUE ET AUX ENERGIES ALTERNATIVES, Paris (FR)

(21) Appl. No.: 13/500,259

(22) PCT Filed: Oct. 5, 2010
(86) PCT No.: PCT/EP2010/006061

§ 371 Date: Apr. 4, 2012

(30) Foreign Application Priority Data
Oct. 5, 2009 (FR) 09/ 04754

(51) Int. Cl. B25J 17/00

(52) U.S. Cl. 74/490.03; 74/490.05; 901/28; 901/23

(57) ABSTRACT

A motor-driven joint of a robot arm comprising a first segment (1), a second segment (2) movably mounted on the first segment, and a motor-drive device mounted between the segments and connected to a control unit, the motor-drive device comprising an actuator (5) arranged to transmit movement in reversible manner to the second segment relative to the first segment, and blocking means (6, 7, 8, 9; 31) that are interposed between the first segment and the second segment and that are controllable to make the transmission of movement temporarily non-reversible, the joint being characterized in that the motor-drive device includes an actuating element mechanically connected to a portion of the blocking means and mounted on one of the segments to be movable, under the effect of a driving force greater than a predetermined threshold, to actuate the blocking means.

### FIELD OF THE INVENTION

The present invention relates to a joint for a robot arm that is intended more particularly for haptic and/or cobotic applications. Haptics is a field of robotics in which robots are used as a force-return interface serving to simulate interactions with virtual physical media. Cobotics is a field of robotics in which robots assist a user, by sharing the same tool or task with the user so as to guide the user, so as to compensate for the weight of the tool, so as to amplify or reduce force, and/or so as to eliminate interfering or unwanted movements of the user.

### BACKGROUND OF THE INVENTION

In general, such a robot arm joint comprises a first segment and a second segment that are hinged to each other via a connection having one degree of freedom, and that are connected together by an actuator that is arranged to move the second segment relative to the first segment. A zone of the second segment is manipulated directly by the user (haptic) or is provided with an element such as a tool that is manipulated by the user (cobotic). A robot arm generally has a plurality of joints of this type, with the number of joints depending on the number of mutually movable arm portions that are needed for performing all of the desired movements.

The invention relates more particularly to applications in which it is not desired to amplify the force provided by the user, but merely to guide the user's movements or to oppose them if they become undesirable, in order to improve the safety of the actions undertaken.

In addition to its natural ability to move the downstream segment or to exert an active force thereon,

Normally, actuation of the arm needs to be transparent for the user, i.e. the user should not feel any resistance to or interference with the movement the user seeks to make; however, when necessary, the arm must be capable of developing high levels of force in order to oppose a movement of the arm and thus prevent the user from performing a movement that is not desirable. This capacity for developing large reaction forces is useful, for example, for simulating an impact against or making contact with a virtual surface (when the arm is used as an interface for virtual reality software), or to define boundaries of a working zone within which it is necessary to keep a tool fastened to the end of the arm. The actuator must therefore be simultaneously fast and powerful. In haptics and in cobotics, these two behaviors may be described by using two magnitudes that characterize the performance of an actuator:
the extent of the mechanical impedance range that the actuator can provide (where “mechanical impedance” is the resistance that the actuator opposes to movement of the arm driven by the effect of an external force), which extent must be as great as possible; and
the time required for transition between smallest mechanical impedance (the robot opposes minimum resistance to movements performed by the user, with the minimum impedance ideally being zero), and greatest mechanical impedance (the robot opposes any movement performed by the user, where the ideal maximum impedance is infinite), and this transition time needs to be as small as possible.

It is known to make use of actuators constituted in particular by pneumatic cylinders, hydraulic cylinders, or electric motors, nevertheless none of those actuators fully satisfies the above conditions. In particular, with electric motors, the more powerful motors are also those that present the greatest amount of inertia and the highest levels of friction, thereby giving rise to transition times that are unacceptable for the intended application. These observations can be extrapolated to other types of actuator.

In order to obviate that drawback, it is known to associate the actuator with a resilient coupling, a magnetic coupling, a coupling including a magneto-rheological fluid, variable speed gearing, . . . in order to increase the mechanical impedance range that the actuator can provide and in order to reduce the transition time between the smallest mechanical impedance and the greatest. The performance of such solutions has been found to be moderately satisfactory, but they are sometimes obtained at the cost of complexity that is relatively great and expensive.

### OBJECT AND SUMMARY OF THE INVENTION

An object of the invention is to provide a motor-driven rotor arm joint capable of improving the safety of haptic or cobotic applications without sacrificing ergonomics or performance.

To this end, the invention provides a motor-driven joint of a robot arm comprising a first segment, a second segment movably mounted on the first segment, and a motor-drive device mounted between the segments and connected to a control unit, the motor-drive device comprising an actuator arranged to transmit movement in reversible manner to the second segment relative to the first segment, and blocking means that are interposed between the first segment and the second segment and that are controllable to make the transmission of movement temporarily non-reversible. The motor-drive device comprises an actuating element mechanically connected to a portion of the blocking means and mounted on one of the segments to be movable, under the effect of a driving force greater than a predetermined threshold, to actuate the blocking means.

The invention thus relies on adding means for unidirectionally blocking the rotation of the second segment, which means act in parallel with the actuator for the purpose of creating a reaction force that opposes the movements that it is desired to avoid. The actuator is thus used for moving the second segment relative to the first segment or for imposing limits on its movement. When limits are imposed, if the external forces exerted on the second segment are greater than a predetermined force, then the blocking means are added to the actuator in order to provide the missing resisting force. These blocking means transmit the external forces directly to the structure of the segment on which the blocking means are mounted. It is particularly simple to put the blocking means into action, with this depending directly on the driving force. The term “driving force” is used to mean a force exerted by the actuator on the actuating elements, this force serving to generate a reaction force. This enables the actuating element to cause the blocking means to be added to the actuator when the force developed by the actuator reaches the predetermined threshold.

In a first embodiment of the motor-drive device, the actuator comprises a motor having an outlet shaft connected to a first wheel engaged with a drive element of the second segment, the actuating element being a support on which the motor is mounted.

Any force exerted by the actuator on the second segment creates a reaction force that is transmitted to the support. If the force exerted in this way by the actuator on the support is greater than the predetermined threshold, then the support is caused to move, thereby actuating the blocking means. The joint in this embodiment presents a structure that is particularly simple and compact.

Advantageously, the second segment is mounted on the first segment to pivot about an axis perpendicular to the first segment, and is secured to a second wheel having the pivot axis as its axis, so that the second wheel forms the drive element of the second segment.

Under such circumstances, in a first embodiment of the blocking means, the support is mounted on the first segment to slide along a circularly arcuate path about the axis of rotation of the second segment between at least an activated position and an inactivated position of a blocking device for blocking rotation of the first wheel, and, preferably, the blocking device comprises a friction pad mounted stationary relative to the first segment and a cylindrical friction pad mounted stationary on the first wheel in such a manner that the pads are in contact with each other in the activated position and are separate from each other in the inactivated position.

When the actuator is blocked and a movement is imparted to the second segment, the second segment exerts a torque on the second wheel, thereby causing the first wheel to slide about the axis of the joint, from the inactivated position to the activated position of the blocking means. This serves to block the first wheel.

In a second embodiment of the blocking means, the support is mounted to pivot on the first segment between at least an activated position and an inactivated position of a blocking device for blocking the second segment.

So long as the tangential force generated by the torque of the joint (the resultant of the drive torque and of the resisting torque opposing the movement of the second segment) is below the predetermined threshold, the second segment turns freely. In contrast, when this tangential force is greater than the threshold, the support of the motor is turned until the support actuates the blocking device. Blocking is thus implemented by exerting a force directly on the second segment.

Advantageously, the blocking device comprises a friction pad fastened eccentrically on the support to extend facing a friction pad secured to the second segment in such a manner that the friction pads are in contact with each other in the activated position and are separate from each other in the inactivated position.

When the tangential force is greater than the threshold, the support of the motor is turned until the pads come into contact and block the second segment. Blocking is thus implemented by exerting a force directly on the second segment. The residual movement of the segment between its position at the instant of triggering and its position in which blocking becomes effective may be adjusted by setting the gap between the pads when the support is in the inactivated position. The smaller this gap the greater the accuracy.

Under such circumstances, and preferably, the pads comprise male and female portions of complementary shapes.

This makes it possible to increase the contact areas of the friction pads, thereby increasing the effectiveness of the blocking and limiting the forces to which the axes are subjected.

Also preferably, the support and the motor are substantially on the same axis.

Balancing the support and motor assembly is relatively simple because of the shared axis. The force exerted by the motor on the support is also independent of the orientation of the arm relative to the gravitational field, in particular when the axis of rotation of the support is not parallel to gravity.

In a second embodiment of the motor-drive device, the second segment is mounted to pivot relative to the first segment, and the motor-drive device comprises a wheel and wormscrew connection for transforming rotation of an outlet shaft of the actuator into pivoting of the second segment relative to the first segment, a blocking device for blocking rotation of the wormscrew being fastened to the first segment and the wormscrew being movable in translation relative to the first segment between an activated position and an inactivated position of the blocking device.

This makes it possible to strengthen the non-reversibility of the transmission of movement that is provided by the wheel and wormscrew connection and makes it possible to have a helix angle that is greater in order to increase the reactivity of the connection.

Preferably, regardless of the embodiment, the predetermined threshold is defined by the rating of at least one spring mounted to exert a force on the actuating element that opposes movement thereof for actuating the blocking means.

This way of defining the threshold is extremely simple. In addition, the threshold may be set simply by adjusting the prestress of the spring.

### BRIEF DESCRIPTION OF THE DRAWINGS

Other characteristics and advantages of the invention appear on reading the following description of particular, non-limiting embodiments of the invention.

Reference is made to the accompanying drawings, in which:

FIG. 1 is a diagrammatic view of an arm in accordance with a second embodiment of the invention;

FIG. 2 is an enlarged perspective view of a zone II of FIG. 1;

FIG. 3 is a diagram showing the relationship between the position of the joint (along the abscissa) and the torque exerted thereon (up the ordinate) during simulation of a contact;

FIG. 4 is a diagrammatic view of the linkage of the non-reversible connection of an arm in accordance with the second embodiment of the invention, in the absence of a force exerted against the abutment;

FIG. 5 is a view analogous to FIG. 4 in the presence of a force exerted on the abutment;

FIG. 6 is a diagrammatic perspective view of a motor-driven joint in accordance with the first embodiment of the invention, in the absence of force exerted on the second segment;

FIG. 7 is a view analogous to the preceding figure, in the presence of a force exerted on the second segment;

FIG. 8 is a view from beneath of the motor-driven joint in accordance with the first embodiment;

FIGS. 9 and 10 are views analogous to the preceding figure showing a variant of the first embodiment, respectively in the absence of and in the presence of a force exerted on the second segment;

FIG. 11 is a diagrammatic view of the linkage of another variant of the first embodiment of the invention, in the absence of force exerted on the second segment;

FIGS. 12 to 14 are views analogous to the preceding figure showing other variants of the first embodiment of the joint;

FIG. 15 is a fragmentary perspective view of a joint in accordance with yet another variant of the first embodiment, in the absence of force exerted on the second segment;

FIG. 16 is a plan view of the joint in accordance with the variant of FIG. 15, in the presence of a force exerted on the second segment;

FIG. 17 is an enlarged view of a zone XVII of FIG. 15; and

FIG. 18 is a fragmentary perspective view of a joint in accordance with a last variant of the first embodiment, in the absence of force exerted on the second segment.

### MORE DETAILED DESCRIPTION

The motor-driven joint in accordance with the invention is described herein for a surgical application. The free end of the arm is fitted with a milling cutter that is manipulated by a surgeon in order to remove unhealthy portions of a patient's body without touching healthy portions.

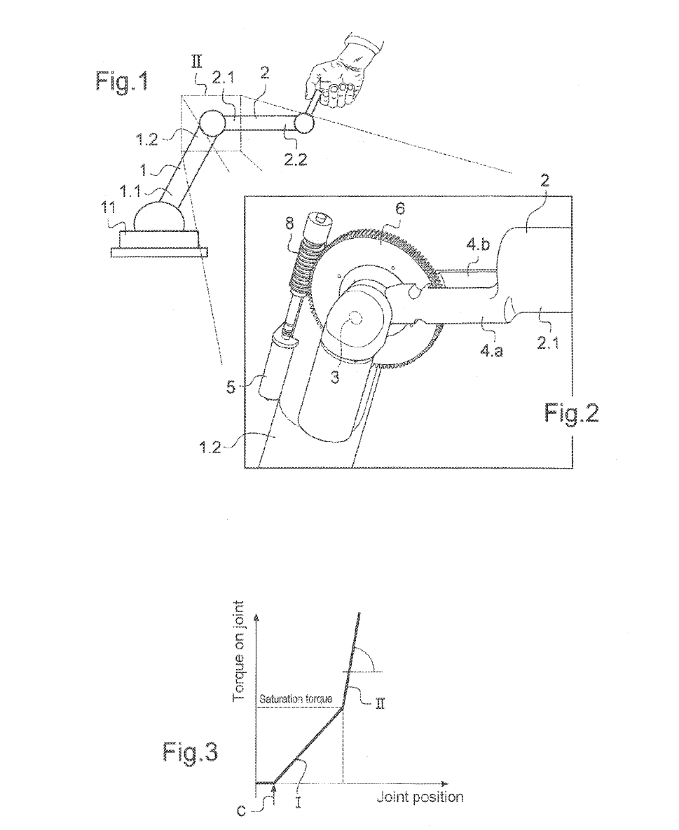

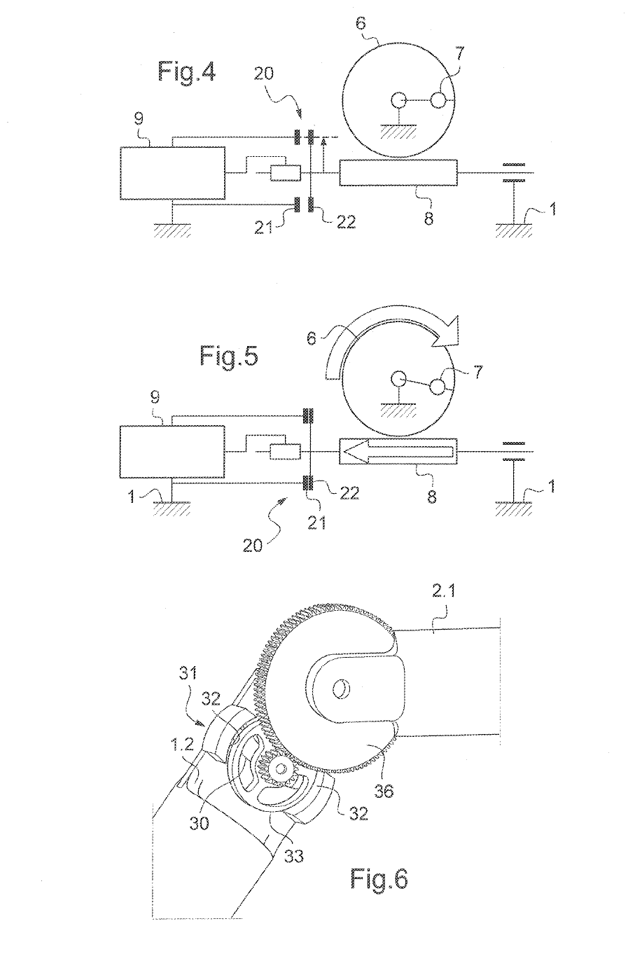

With reference to FIGS. 1 to 5, the arm joint in accordance with a second embodiment of the invention comprises a first segment 1 and a second segment 2 that extend on either side of the arm joint to form portions of the arm. The segments may thus be integral with the arm portions, or they may be fastened thereto in permanent or removable manner.

The first segment 1 has a first end 1.1 connected to a stand 11 and a second end 1.2 having a shaft 3 secured thereto with a first end 2.1 of the second segment 2 pivotally mounted thereon, the segment 2 having an opposite, second end 2.2 that is provided with a tool (not shown). The first end 2.1 in this example is U-shaped, having branches 4.a and 4.b with their free ends fastened to pivot on the shaft 3. The first end may naturally have some other shape, for example it may be of a simpler shape, having only one branch.

A gearwheel 6 secured to the end 2.1 of the second segment 2 is mounted to pivot on the shaft 3 between the branches 4.a and 4.b.

The gearwheel 6 meshes with a wormscrew 8 that is fastened on the first segment 1 to pivot about an axis parallel to the longitudinal direction of the first segment 1 and perpendicular to the shaft 3. The wormscrew 8 has one end connected to rotate with an outlet shaft of a motor 5 secured to the first segment 1.

The motor 5 constitutes the actuator of the motor-driven joint connecting together the first and second segments, and it is dimensioned so as to move the assembly comprising the gearwheel 6 and the wormscrew 8, and thus to move the second segment 2 relative to the first segment 1 or to oppose a fraction of the forces tending to move the second segment 2 relative to the first segment 1.

The arm also includes a blocking device 20 for blocking rotation of the wormscrew 8. The device 20 is fastened on the first segment 1 and the wormscrew 8 is movable in translation relative to the first segment 1 between a position in which the blocking device 20 is activated and a position in which it is inactivated.

The blocking device 20 comprises a friction pad 21 mounted stationary relative to the first segment 1 and a friction pad 22 mounted stationary on the wormscrew 8 so that the pads 21 and 22 are in contact with each other in the activated position and are separated from each other in the inactivated position.

The wormscrew 8 is connected to the outlet shaft of the motor 5 so as to be constrained to rotate together therewith while being free to move in translation relative to said outlet shaft.

The motor 5 is connected to a control unit 10. The control unit 10 is a computer arranged to execute a program for controlling said motor. In the intended surgical application, the control program defines a working zone that is defined by a boundary envelope that is itself determined by using medical imaging. The control unit 10 controls the motor 5 so that the arm follows the movements of the cutter manipulated by the surgeon within the limits of the boundary envelope and blocks the motor 5 in order to oppose any movement of the cutter out from the limits of the boundary envelope.

As can be seen in FIG. 3, during simulation of a contact (point C), the motor 5 is controlled to resist (increase in torque I) before the blocking device 20 is actuated (increase in torque II). The envelope can be tracked within the portion I of the curve.

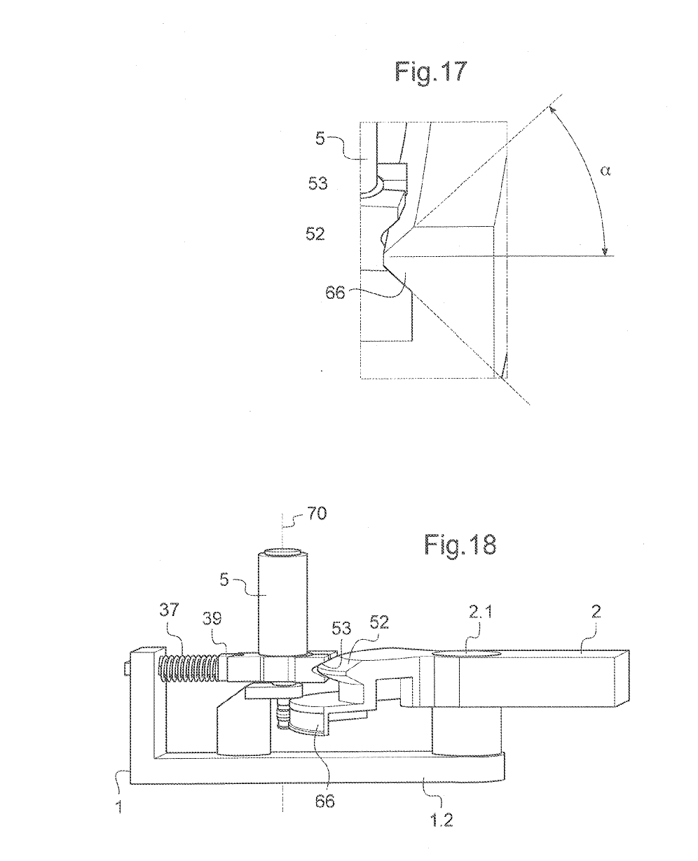

Elements that are identical or analogous to those described above are given the same numerical references in FIGS. 6 to 18 relating to the first embodiment and to its variants.

In the first embodiment as shown in FIGS. 6 to 8, the second segment 2 is mounted on the first segment 1 to pivot about an axis perpendicular to the first segment 2, and it is secured to a first wheel 36 having the pivot axis as its axis. The actuator comprises an electric motor 5 having an outlet shaft connected to a second wheel 38. In this example the wheels 36 and 38 are gearwheels that mesh with each other. In this example the outlet shaft of the motor 5 is pivotally mounted on a circularly arcuate slider 35 that forms a support for the motor 5 and that is received in a circularly arcuate slot 30 formed in the first segment 1 (the end 1.2 forms a plate in this example). The slider 35 can slide along the slot so that the wheel 38 presents freedom to move through an angle about the axis of rotation of the second segment 2 between at least an inactivated position of a blocking device 31 for blocking rotation of the wheel 38 and two activated positions of said device, the activated positions being situated on either side of the inactivated position.

The blocking device 31 has two friction pads 32 mounted stationary relative to the first segment at respective ends of the slot 30, and a friction pad 33 mounted stationary on the wheel 38. The wheel 38 is a staged wheel, having a toothed portion for co-operating with the gearwheel 36 and another portion with a periphery that is provided with the pad 33 that is cylindrical in shape.

The pad 33 is urged towards the inactivated position by return springs 34 (visible in FIG. 8 where the motor 5 is omitted), which springs are tangential to the slot 30 and interposed between the end 1.2 and each of the sides of the slider 35.

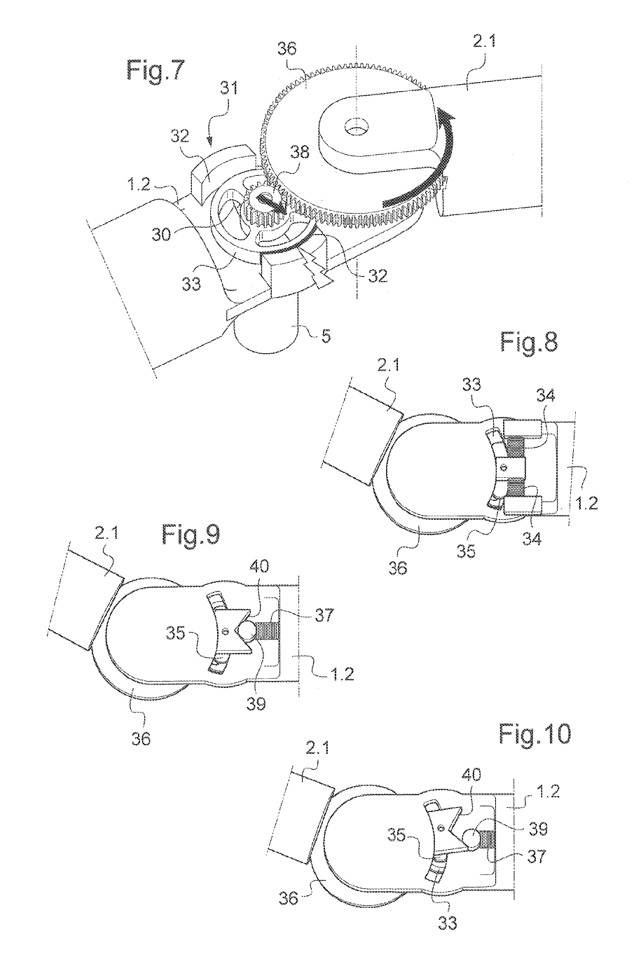

In the inactivated position, the wheel 38 extends substantially in the middle of the slot 30 and the pad 33 is separated from the pads 32 (FIG. 6). When the motors 5 and 9 are blocked and a rotary force is applied on the second segment 2, the second segment 2 causes the wheel 36 to turn, thereby moving the wheel 38 into one of the activated positions in such a manner that the pad 33 and the corresponding pad 32 (depending on the direction of the torque acting on the wheel 36) come into mutual contact (FIG. 7).

It should be observed that the pads 32 are circularly arcuate in shape, having a radius equal to the radius of the pad 33 so as to increase the contact area between the two pads.

It is necessary for the springs 34 to be dimensioned so that the pad 33 comes into contact against one of the pads 32 before the motor has produced its maximum force.

It can be understood that any force exerted by the actuator on the second segment creates a reaction force that is transmitted to the support that tends to slide towards one or the other of the pads 32.

The resisting force delivered by the spring 34 opposing the sliding of the slider 35 constitutes a first force threshold to be overcome in order to move the slider 35 and thus the segment 2, and the friction between the pads 32 and 33 defines a second force threshold to be overcome in order to move the second segment 2. It is possible to control the motor 5 so as to move the wheel 38 so as to bring the pad 33 more quickly against the pad 32 by driving the wheel 38 in the direction in which said wheel 38 is already being driven by the wheel 36. This then eliminates the damping force provided by the springs 34.

The position of the motor 5 and thus of the wheel 38 may be determined for example as a function of detecting that one or more force thresholds have been crossed, on the basis of a force model delivered by the motor, or else by means of a dedicated sensor.

In the variant of FIGS. 9 and 10, the pad 33 secured to the wheel 38 is urged towards the inactivated position by a return spring 37 extending radially relative to the wheel 36 and having one end bearing against the end 1.2 and one end acting on a cam-follower wheel 39 received in a V-shaped notch 40 formed in the slider 35. The angle of the V-shape serves to adjust the force relationship produced by the spring 37 when it opposes movement of the pad 33. It is necessary for the pad 33 to come into contact against one of the pads 32 before the motor produces its maximum force.

The blocking device 31 may be arranged to ensure that the pad 33 is movable in translation in a straight line.

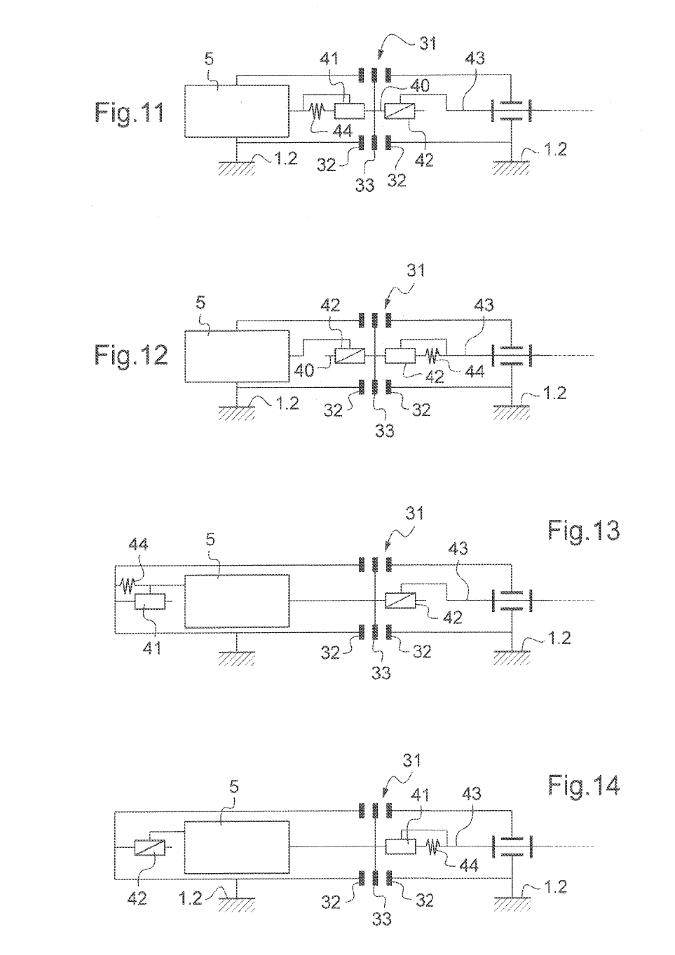

Thus, in the variant of FIG. 11, the pad 33 is made in the form of a disk that is received between the pads 32 and that is secured to an intermediate shaft 40 on the same axis as the outlet shaft of the motor 5. The intermediate shaft 40 is connected by a slideway connection 41 to the outlet shaft of the motor 5 and by a helical connection 42 to a final shaft 43 secured to the wheel 38. A spring 44 holds the intermediate shaft in a middle position in which the pad 33 is separate from the pads 32. The helical connection is arranged so that in the absence of a resisting force greater than a predetermined threshold, rotation of the intermediate shaft drives the final shaft in rotation. In contrast, if the motor 5 is blocked, then rotation of the segment 2 and thus of the final shaft will act via the helical connection to drive sliding of the intermediate shaft so as to bring the pad 33 into contact with one of the pads 32.

In the variant of FIG. 12, the positions of the slideway connection 41, of the helical connection 42, and of the spring 44 are reversed.

In the variant of FIG. 13, the motor 5 is mounted on the end 1.2 via a slideway connection 41, and the outlet shaft of the motor 5 directly supports the pad 33 and is connected to the final shaft 43 via the helical connection 42.

In the variant of FIG. 14, the positions of the slideway connection 41, of the helical connection 42, and of the spring 44 are reversed.

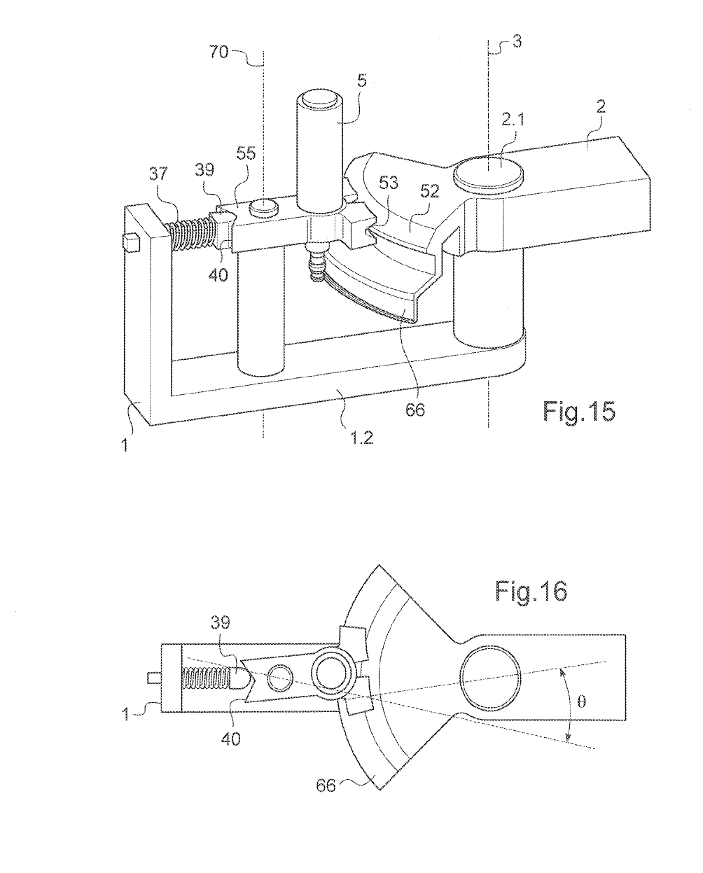

With reference to FIGS. 15 to 17, and in another variant, the joint comprises a support 55 mounted on the first segment 1 to pivot about an axis 70 parallel to the axis of the joint between the second segment 2 and the first segment 1. The motor 5 is mounted on the support 55 in such a manner that its outlet shaft extends parallel to the axis 70. The outlet shaft of the motor 5 engages via a cable with a wheel 66 (only a portion of which is visible in the figures) that is secured to the end 2.1 of the second segment 2. The outlet shaft may also carry a gearwheel meshing with a set of teeth formed on the wheel 66.

Beside the motor 5, the support 55 has an end provided with a friction pad 53 extending tangentially facing a circularly arcuate friction pad 52 secured to the wheel 66 and having the same axis. The pad 53 extends on either side of a midplane of the support 55 containing the axis 70. The support 55 is in the inactivated position when the support 55 extends radially relative to the pad 52. In this position, there is a gap between the pads 52 and 53. The support 55 is in the activated position when the pad 52 and the pad 53 are in contact with each other. The support 55 (more precisely the axis extending between the axis 70 and the point of contact between the pads 52 and 53) then forms an angle with the radius of the pad 52 passing through the point of contact between the pads 53 and 52 (see FIG. 16).

With a plane surface contact, the blocking condition is written:

tan(θ)<μ

where θ is the angle between the support 55 and the radius in question, and μ is the coefficient of friction of the pair of materials constituting the pads. In order to reduce axial forces on the joint, the contact areas of the pads 52 and 53 preferably comprise male and female portions of complementary shapes. In this example, the pads 52 and 53 are contact surfaces defining a V-shape in cross-section. Labeling the half-angle at the apex of V as α, it is necessary to have:

tan(θ)sin(α)<μ

as the blocking condition and:

tan(α)>μ

to avoid jamming in the V-shape that might otherwise oppose release of the wheel 66. In a variant, the pads 52 and 53 may have contact surfaces that define superposed V-shapes in cross-section (like in a grooved pulley).

The support 55 is urged towards the inactivated position by a return spring 37 that extends radially relative to the wheel 36, having one end bearing against the end 1.2 and another end bearing against a cam-follower wheel 39 received in a V-shaped notch 40 formed in the support 55. The angle of the V-shape serves to adjust the relationship for the force produced by the spring 37 when it opposes movement of the pad 53. It is necessary for the pad 53 to come into contact against the pad 52 before the motor has produced its maximum force.

It should be observed that it is easy to prestress the spring 37 so as to adjust the threshold at which the blocking device is triggered. For example, provision may be made for a nut that is mounted on the same axis as the finger carrying the cam-follower wheel 39 in order to shorten the length of the spring 37.

In the last variant as shown in FIG. 18, the only difference relative to the variant of FIGS. 15 to 17 is that the motor 5 lies substantially on the axis 70.

Naturally, the invention is not limited to the embodiment described but covers any variant coming within the ambit of the invention as defined by the claims.

In particular, the first segment may be formed by a portion of the arm, by a trunk, or by a stand of a robot.

The structure of the arm may differ from that described: by way of example the second segment may be movable in translation relative to the first segment. Conversely, the actuator may be a jack driving a rack that meshes with a gearwheel, or it may be a motor driving a wheel that runs along an optionally rectilinear track. It is also possible to envisage inverting the linkage.

The arm may include an actuator for each of its joints or for only one or some of them (trunk, shoulder, elbow, wrist, . . . ).

The segments may be of shapes other than those shown. In the first embodiment, the end 2.1 of the second segment may comprise only one arm and the axis supporting the wheels 6 may project laterally from the end 1.2.

What is claimed is:

1. A motor-driven joint of a robot arm comprising a first segment (1), a second segment (2) movably mounted on the first segment, and a motor-drive device mounted between the segments and connected to a control unit, the motor-drive device comprising an actuator (5) arranged to transmit movement in reversible manner to the second segment relative to the first segment, and blocking means (6, 7, 8, 9; 31) that are interposed between the first segment and the second segment and that are controllable to make the transmission of movement temporarily non-reversible, wherein the motor-drive device includes an actuating element mechanically connected to a portion of the blocking means and mounted on one of the segments to be movable, under the effect of a driving force greater than a predetermined threshold, to actuate the blocking means.

2. A joint according to claim 1, wherein the actuator comprises a motor (5) having an outlet shaft connected to a first wheel (38) engaged with a drive element of the second segment, the actuating element being a support on which the motor is mounted.

3. A joint according to claim 2, wherein the second segment (2) is mounted on the first segment (1) to pivot about an axis (32) perpendicular to the first segment, and is secured to a second wheel (36) having the pivot axis as its axis, so that the second wheel forms the drive element of the second segment.

4. A joint according to claim 3, wherein the support is mounted on the first segment to slide along a circularly arcuate path about the axis of rotation of the second segment between at least an activated position and an inactivated position of a blocking device (31) for blocking rotation of the first wheel.

5. A joint according to claim 4, wherein the blocking device comprises a friction pad (32) mounted stationary relative to the first segment and a cylindrical friction pad (33) mounted stationary on the first wheel in such a manner that the pads are in contact with each other in the activated position and are separate from each other in the inactivated position.

6. A joint according to claim 2, wherein the support is mounted to pivot on the first segment between at least an activated position and an inactivated position of a blocking device (31) for blocking the second segment.

7. A joint according to claim 6, wherein the blocking device comprises a friction pad fastened eccentrically on the support to extend facing a friction pad secured to the second segment in such a manner that the friction pads are in contact with each other in the activated position and are separate from each other in the inactivated position.

8. A joint according to claim 7, wherein the pads comprise male and female portions of complementary shapes.

9. A joint according to claim 6, wherein the support and the motor are substantially on the same axis.

10. A joint according to claim 6, wherein the drive element is a wheel centered on an axis of rotation of the second segment relative to the first segment.

11. A joint according to claim 6, wherein the drive element is a rack and the pad secured to the support is of a substantially circular arcuate shape centered on the pivot axis of the support.

12. A joint according to claim 1, wherein the second segment is mounted to pivot relative to the first segment, and the motor-drive device comprises a wheel and wormscrew connection for transforming rotation of an outlet shaft of the actuator into pivoting of the second segment relative to the first segment, a blocking device (20) for blocking rotation of the wormscrew (8) being fastened to the first segment (1) and the wormscrew being movable in translation relative to the first segment between an activated position and an inactivated position of the blocking device.

13. A joint according to claim 12, wherein the blocking device (20) comprises a friction pad (21) that is mounted stationary relative to the first segment (1), and a friction pad (22) that is mounted stationary on the wormscrew (8) in such a manner that the pads are in contact with each other in the activated position and are separate from each other in the inactivated position.

14. A joint according to claim 1, wherein the predetermined threshold is defined by the rating of at least one spring mounted to exert a force on the actuating element that opposes movement thereof for actuating the blocking means.

15. A joint according to claim 14, wherein the actuating element presents a housing having a substantially V-shaped end for receiving a finger mounted on the segment to slide along a direction that is substantially normal to the path of the actuating element, the spring extending between the segment and the finger in order to force the finger to bear against the end of the housing.

16. A joint according to claim 14, wherein the spring extends tangentially to a path of the actuating element in order to oppose movement of the actuating element for actuating the blocking means.
